(19) United States
(12) Patent Application Publication
(10) Pub. No.: US 2005/0064135 A1
(43) Pub. Date: Mar. 24, 2005

(54) Perimeter tubular element for attachment to frame opening, in particular automobile frame

(76) Inventor: Jean-Philippe Perrin, Faulquemont (FR)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/947,882

(22) Filed: Sep. 23, 2004

(30) Foreign Application Priority Data
Sep. 23, 2003 (FR) 03 11140

(51) Int. Cl. B32B 3/04

(52) U.S. Cl. 428/122

(57) ABSTRACT

The element (1) comprises a securing portion (5) having a U-shaped section and a flexible tubular cushion seal (6) connected to the securing portion with a connecting strip (9) that is offset in relation to the axis of the neutral bending fiber along a curve in a globally perpendicular direction to the lateral side of the shaped element. When there is a curve in such a direction, the cushion tilts toward the securing portion instead of deforming, thereby eliminating the appearance of unattractive creases and limiting crushing at the top of the element. Preferably, the connecting strip is inclined at an angle that facilitates tilting by the cushion seal and comprises a hinged area (23) of reduced thickness. The securing portion may comprise a raised contact area (24) which the cushion seal abuts after tilting. This invention is of interest to manufacturers of elements and automobile manufacturers.

The present invention concerns a shaped perimeter element designed for attachment to a metal, plastic, or composite rim, particularly the frame surrounding the opening in an automobile body such as, for example, the engine hood, a door, a compartment, or a non-sliding window that opens.

To ensure mechanical protection, sealing, and a certain degree of soundproofing at the level of the frames called “window jambs” on an automobile body, the method known in the art is to cover the edges of these frames with a perimeter element.

Conventionally, these elements are shaped elements constituting a securing portion for positioning and retaining the element on the rim and a flexible cushion seal which the opening unit abuts in the closed position in order to form a seal and provide soundproofing.

Most often, the securing portion has a generally U-shaped section before it is compressed for attachment to the rim. It is made of a relatively rigid material, generally a rigid plastic or hard rubber, and may be reinforced with a metal frame.

To improve retention of the element on the metal rim, the interior surfaces facing the two branches of the U-shaped securing portion generally comprise retaining lips located opposite each other.

The cushion seal is a hollow tubular shaped element made of a more flexible material, usually rubber, which may or may not be thermoplastic, or cellular or compact foam which can be flattened when compressed. It extends longitudinally along one of the exterior surfaces of the securing portion determined as a function of the angle of the rim of the vehicle body and the relative position of the opening unit. For example, in the case of the perimeter element for an engine hood, the cushion seal is attached to the upper surface of the securing portion.

The two portions which constitute the element may be formed simultaneously in a co-extrusion operation or they may be formed separately and attached to each other in a later step.

Shaped seals of this type are widely known and have been described in numerous patent applications, such as, for example, FR 2.629,128, EP 0.805.058, FR 2.502.563, EP 0.427.372, EP 0.300.736, WO 97/08003, EP 0.425,083. EP 1.123.827, EP 1.138.538, etc.

When the shaped elements known in the art are attached to the rim of a vehicle frame, a problem is encountered when there is a change in direction consisting of a slight curve generally perpendicular to the side of the rim.

If the radius of this curve is not too significant, the securing portion is generally flexible enough to bend in a direction globally perpendicular relative to its lateral side in order to accommodate the curve. However, at the level of the curve, the tubular cushion is stretched on the exterior of the curve and compressed on the inside of the curve. A series of particularly unattractive creases form in succession in the tubular cushion on the inside of the curve. In addition, this causes undesirable vertical compacting in the element, reducing its soundproofing and soundproofing properties.

For all these reasons, the operator is often obliged to miter the element at the point where it changes direction and then reconnect the two portions on either side of the corner using cross braces, for example. This operation is sometimes problematic. Furthermore, it increases the time required to position the element and raises assembly costs.

The object of the invention is to provide a shaped perimeter element similar in structure to the two elements previously described, that is, comprising a securing portion with a generally U-shaped section and a flexible tubular cushion seal, but without this disadvantage.

The element according to the invention is designed for attachment to the edge of a vehicle frame that may consist of a metal return, either upright or with at least two metal returns in coplanar juxtaposition, which may be soldered together at points.

Advantageously, the element of the invention is able to accommodate a curve with a radius that is essentially perpendicular to its lateral side without any unattractive creases forming in the tubular cushion. Furthermore, the element is vertically flattened to a limited extent only, which allows better contact with the opening unit and improved tightness of the element and better soundproofing.

For this reason, it is possible to use a single continuous portion of the shaped element according to the invention, even in the case of a non-rectilinear rim with areas that change direction and have slightly curving portions essentially perpendicular to the side of the rim. This eliminates the need to cut and reconnect the element.

In that case, the cushion seal is connected to the securing portion by a connecting strip that is offset from the axis of the neutral bending fiber curving in a globally perpendicular direction to the lateral side of the shaped element.

When there is a curve that is generally perpendicular to the lateral side of the element, the cushion seal angles toward the securing portion instead of deforming, thereby preventing the formation of unattractive creases.

In a preferred manner, the connecting strip is not parallel to the plane of the securing portion, but is angled to facilitate tilting by the cushion seal. It may further comprise an area that bends easily, preferably in the form of an area of reduced thickness serving as a hinge.

Advantageously, the securing portion may comprise a raised contact area which the cushion seal abuts after tilting, which limits tilting along the curve.

Other features and advantages of the invention will be apparent from reading the following detailed description, in conjunction with the attached drawings, wherein:

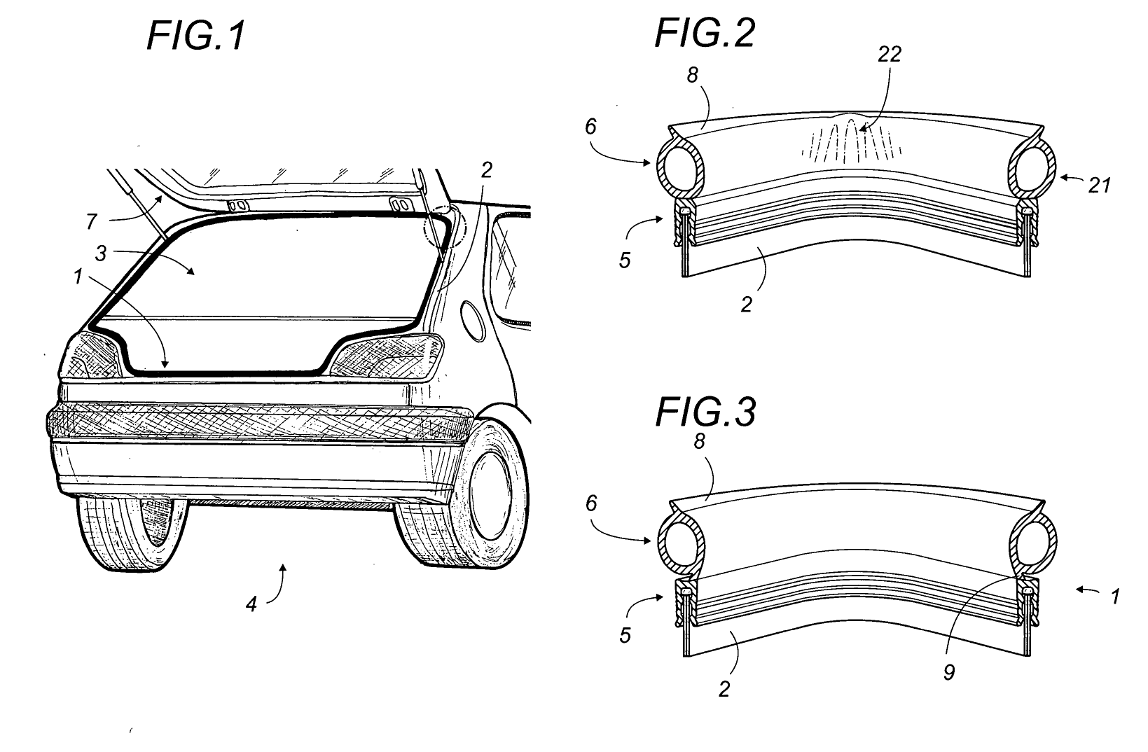

FIG. 1 is a global perspective of the rear of an automobile having the frame of its rear compartment equipped with a perimeter element according to the invention;

FIG. 2 is an enlargement of the circled detail of FIG. 1 showing a curved area along the frame, extracted and horizontally aligned, equipped with a perimeter element according to the prior art;

FIG. 3 is an enlargement of the circled detail of FIG. 1 showing a curved area along the frame, extracted and horizontally aligned, equipped with a perimeter element according to the present invention;

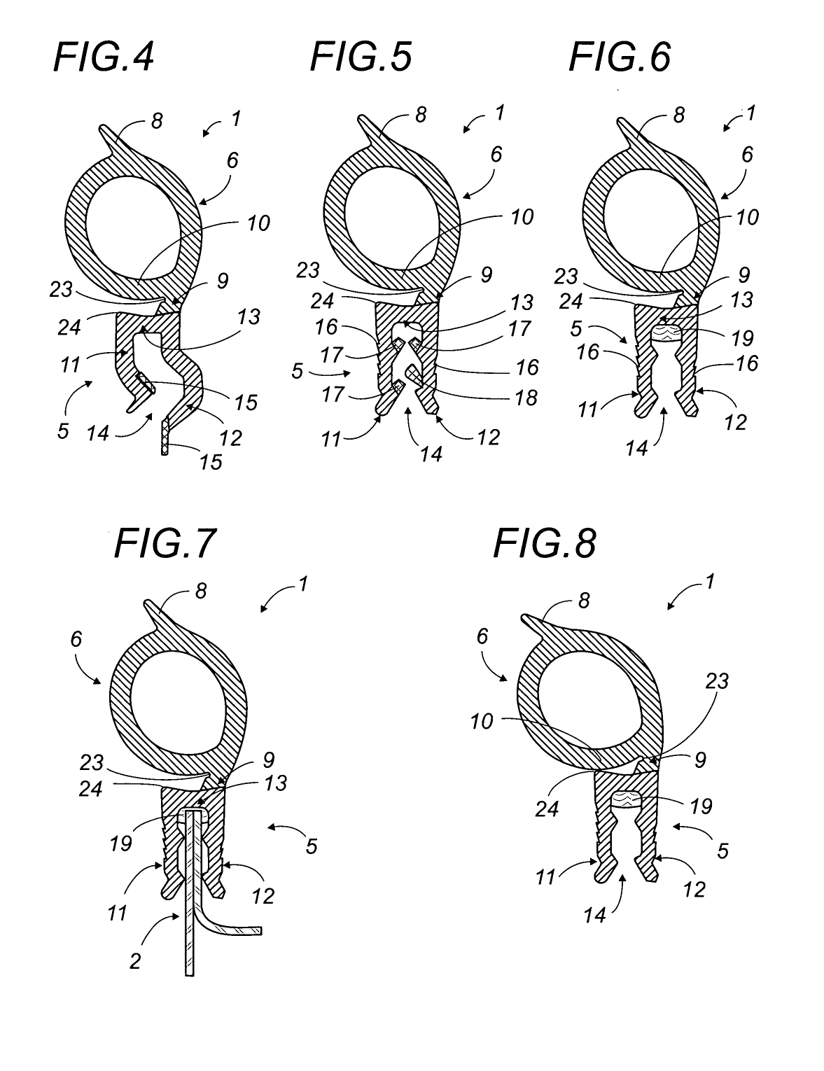

FIG. 4 is a transverse cross-section of an unattached perimeter element according to a first embodiment of the invention, with the cushion seal in an upright position;

FIG. 5 is a transverse cross-section of an unattached perimeter element according to a second embodiment of the invention, with cushion seal in an upright position;

FIG. 6 is a transverse cross-section of an unattached perimeter element according to a third embodiment of the invention, with the cushion seal in an upright position;

FIG. 7 is a transverse cross-section of a perimeter element according to the third embodiment of the invention attached to a return on the vehicle frame, with the cushion seal in an upright position;

FIG. 8 is a transverse cross-section of an unattached perimeter element according to a third embodiment of the invention, with the cushion seal in the angled position;

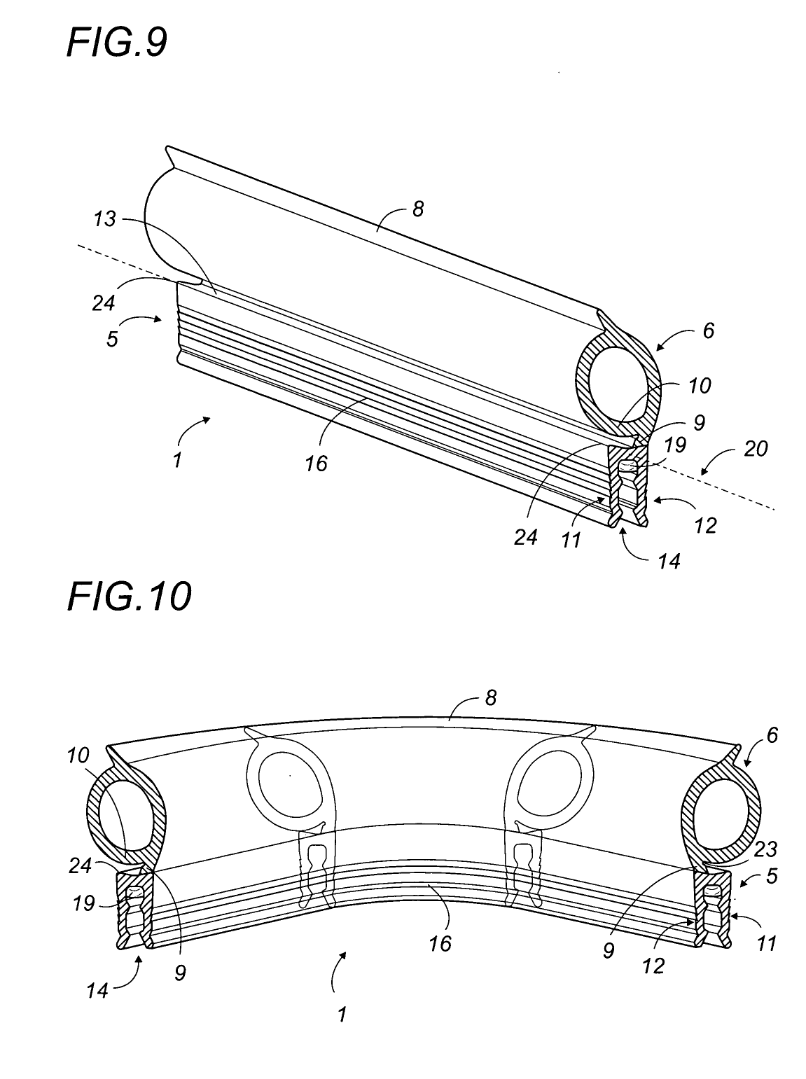

FIG. 9 is a perspective view of a portion of an unattached perimeter element according to the third embodiment of the invention in the free state, with the cushion seal in upright position; and

FIG. 10 is a perspective view of a portion of the perimeter element according to the third embodiment of the invention where it follows is a curvature, with the cushion seal angled at the level of the curve.

The element of the present invention will now be described in detail with reference to FIGS. 1 through 10. Equivalent elements shown in different drawings will bear the same reference numerals.

One mode of realization of a shaped element 1 according to the invention has been shown in a specific situation, attached to a rim 2, for example, a metal rim, constituting the frame of opening 3 of the rear compartment of an automobile 4 in the global perspective view of FIG. 1.

In the different drawings, the element shown corresponds to specific embodiments of the invention designed for the frame of a trunk or an engine hood opening on an automobile.

However, it should be understood that these are only examples of preferred embodiments of the invention; a person skilled in the art would easily be able to make the modifications necessary for adaptation to other applications without exceeding the scope of the present invention.

Element 1 of the invention comprises a securing portion 5 to which a cushion seal 6 is attached.

Cushion seal 6 has a hollow tubular profile made of flexible thermoplastic or elastomeric material permitting it to be flattened when the interior surface of the hood or tailgate 7, for example, contacts it in the closed position, thus providing a certain degree of sealing.

Preferably, cushion seal 6 is made of flexible plastic material. Therefore, profile element 1 may be composed entirely of plastic material.

Cushion seal 6 may, for example, comprise a longitudinal lip 8 at the upper portion, improving contact with the wall of the hood or tailgate 7 and thus reinforcing the seal.

In the different variations shown, cushion seal 6 extends longitudinally above securing portion 5.

Cushion seal 6 is attached to securing portion 5 by means of a continuous connecting strip 9 forming the preferred connection between the lower portion 10 of cushion seal 6 and securing portion 5.

Securing portion 5 has a generally U-shaped section which must be compressed when attaching it to rim 2 of the metal which is to be equipped with the element, as can be seen in FIGS. 3 and 7.

The base structure of securing portion 5 is preferably made of a rigid or sem-rigid plastic material.

It comprises two lateral branches 11 and 12 opposite each other and extending globally downward.

These branches 11 and 12 are joined at their upper portions by an essentially horizontal connecting bridge 13 and they define a reception channel 14 for edge 2 of the frame to be equipped.

Various embodiments can be envisioned for securing portion 5, which is not essential to the invention and therefore may be any type. Some examples have been shown in FIGS. 4 through 6.

The securing portion 5 shown in FIG. 4 has features which the applicant has previously patented.

In this embodiment, the two lateral branches 11 and 12 are of different lengths and extend globally downward while remaining essentially parallel, but non-rectilinear.

Below the essentially vertical upper portion, they are angled at approximately 45° in relation to the vertical, then they revert toward the opposite side at an angle of about 90°. The longer branch then extends into an essentially vertical extremity.

Reception channel 14 therefore has an essentially constant width and a generally S-shaped profile.

Lateral branches 11 and 12 of the securing portion each comprise a support base 15 made of plastic material with a high coefficient of friction, located near the area designed to contact the rim to be equipped.

In the embodiment of FIG. 5, branches 11 and 12 are essentially vertical and are the same length.

On their outside walls they have deformations 16 for use in gripping the element when the operator positions them. To prevent them from interfering with calibration, deformations 16 are preferably hollow and do not project. For example, they may be longitudinal grooves, as shown.

In the usual way, the interior surface of lateral branches 11 and 2 may comprise one or more retaining lips made of a more flexible and/or higher friction material.

Thus, the embodiment of FIG. 5 comprises four wedge points 17, facing each other two by two, designed to wedge against the rim of the vehicle body and to play the role of anti-jerking elements. One of these points has a specifically shaped anti-return lip 18 that forms a buttress to prevent the element from accidentally pulling away.

The embodiment shown in FIG. 6 is similar in structure to that of FIG. 5, but it has no retaining lips or wedge points inside its reception channel 14.

The element is retained on the metal edge of vehicle body 2 by gluing it with adhesive material, preferably a bead of glue 19 such as a polyurethane type glue. The bead of glue may be formed in the base of the channel, for example, simultaneously with extrusion of securing portion 5.

This variation is particularly advantageous because the extrusion operations may be simplified due to the very simple structure of profile element 1 and the absence of anti-jerking elements in reception channel 14. Furthermore, it fulfills the requirements for such a perimeter element perfectly. In practice, since the reception channel is empty, only a slight effort is required for attachment, but because of the gluing, a considerable effort is required for removal.

For purposes of simplification, this variation of the securing portion has also been shown in FIGS. 2, 3, and 7 through 10. However, any other variation of the securing structure could be used without departing from the scope of the invention.

According to an essential characteristic of the invention, connecting strip 9 joining cushion seal 6 to securing portion 5 is offset from the plane of the securing portion or from the longitudinal median axis 20 of bridge connection 13 on securing portion 5. It is also offset in relation to the neutral bending fiber following the curve in a globally perpendicular direction to the lateral side of the shaped element which is located at the level of this axis.

This configuration of the junction area between the two portions, 5 and 6, constituting the shaped element is particularly original.

In fact, in shaped elements of this type known in the prior art, the junction between cushion seal 6 and securing portion 5 is achieved conventionally at the level of this longitudinal median axis 20 or else it is symmetrical with the axis, as is the case in prior art element 21 shown in FIG. 2.

On this prior art element 21, portion 10 of cushion seal 6 is connected to the entire length of bridge connection 13 on securing portion 5. If there is a curve that is globally perpendicular to the lateral side of the profile, the cushion seal cannot make any adaptive movement to limit the effect of the curve. Its lateral wall on the outside of the curve becomes stretched and its lateral wall on the inside of the curve is compressed. Thus, a series of successive creases 22 form along the latter wall that are particularly unattractive.

Conversely, the advantageous configuration of the junction zone of shaped element 1 according to the invention prevents cushion 6 from becoming crushed and unattractively creased when it reaches a slight curve or an angle without the need for mitering.

If there is a curve that is globally perpendicular to the lateral side of the shaped element, as shown in FIGS. 3, 8 and 10, cushion 6 tilts toward the free area on securing portion 5 at the level of the curve, thereby limiting deformation and avoiding the appearance of creases.

This tilting action is facilitated by the disposition of connecting strip 9 at the appropriate angle relative to the plane of securing portion 5 as shown in the different drawings.

Preferably, connecting strip 9 comprises an area that bends easily, for example, an area 23 of reduced thickness acting as a hinge.

When it is finished tilting, cushion seal 6 abuts securing portion 5.

Advantageously, the securing portion may have a raised contact area 24 at its upper portion which the cushion seal contacts. This contact area 24 limits the tilting action of cushion seal 6 so that it conserves optimal sealing and soundproof qualities regardless of its configuration.

In the preferred embodiments shown the upper part of securing portion 5 is symmetrical. Thus, there is a raised area like area 24 on either side, giving it the shape of an anvil.

It is obvious that a person skilled in the art could envision many other variations of the shaped element of the invention and conceive of numerous adaptations, depending upon the application in question.

For example, it might be possible for the shaped element of the invention to have a cushion seal 6 of variable thickness, with certain suitable locations being thinner to facilitate flattening the cushion.

It is clear, however, that all these variations remain within the scope of the invention as defined by the following claims.

1-10. (CANCELED)

11. A shaped perimeter element (1) designed for attachment to a rim (2) capable of forming a curve with a small radius essentially perpendicular to a side of the rim and specifically extending in a frame of an opening in an automobile body, the element comprising an attaching portion (5) with a generally U-shaped cross section which must be compressed in order to attach to the rim (2) and a flexible cushion seal (6) extending longitudinally along an exterior surface of the attaching portion, the attaching portion (5) comprising two branches (11, 12) opposite each other, joined at a level of an upper portion by an essentially horizontal bridge connection (13) and defining a reception channel (14) for the rim (2), the cushion seal (6) is connected to the attaching portion (5) by a continuous connecting strip (9) that is offset in relation to an axis of a neutral bending fiber following a curve in a globally perpendicular direction to a lateral side of the shaped perimeter element, thereby permitting the cushion seal (6) to tilt toward a free area on the attaching portion (5) when there is the curve in the globally perpendicular direction to the lateral side of the shaped perimeter element (1).

12. The shaped perimeter element according to claim 11, wherein the continuous connecting strip (9) forms a junction between a lower portion (10) of the cushion seal (6) and the attaching portion (5).

13. The shaped perimeter element according to claim 11, wherein the connecting strip (9) is inclined at an angle relative to a plane of the attaching portion which facilitates tilting by the cushion seal (6) when the shaped perimeter element (1) curves in the globally perpendicular direction to the lateral side of the shaped perimeter element.

14. The shaped perimeter element to claim 11, wherein the connecting strip (9) comprises an area that bends (23).

15. The shaped perimeter element to claim 14, wherein the area that bends has a reduced thickness (23) that serves as a hinge for the shaped perimeter element.

16. The shaped perimeter element to claim 11, wherein the attaching portion (5) comprises a raised contact area (24) which abuts with the cushion seal (6) after tilting.

17. The shaped perimeter element to claim 16, wherein the contact area (24) is located on an upper portion of the attaching portion (5) and the upper portion of the attaching portion (5) is symmetrically shaped and has a raised area (24) on a first side and a second side that provides the attaching portion (5) with anvil shape.

18. The shaped perimeter element to claim 11, wherein the exterior surface of the two branches (11, 12) of the attaching portion (5) comprise hollow deformations (16) with facilitate gripping of the shaped perimeter element (1.

19. The shaped perimeter element to claim 11, wherein an interior surface of the lateral branches (11, 12) of the attaching portion (5) comprise at least one of a retaining lip and a wedge point (17, 18) made from at least one of a flexible and high friction material.

20. The shaped perimeter element to claim 11, wherein the perimeter element further comprises a bead of glue (19) formed simultaneously with extrusion of the attaching portion (5) and for ensuring that the shaped perimeter element (1) is retained on the rim (2).
